(19) United States
(12) Patent Application Publication
(10) Pub. No.: US 2024/0027246 A1
(43) Pub. Date: Jan. 25, 2024

(54) THERMAL TYPE FLOWMETER AND MANUFACTURING METHOD OF THERMAL TYPE FLOWMETER

(71) Applicant: Surpass Industry Co., Ltd., Saitama (JP)

(72) Inventor: Hiroshi IMAI, Saitama (JP)

(21) Appl. No.: 18/224,161

(22) Filed: Jul. 20, 2023

(30) Foreign Application Priority Data
Jul. 21, 2022 (JP) 2022-116556

(51) Int. Cl. G01F 1/684; G01F 1/69; G01F 15/18

(52) U.S. Cl. CPC G01F 1/6847; G01F 1/69; G01F 15/185

(57) ABSTRACT

Provided is a thermal type flowmeter including: a resin channel member; a plate member defining, together with the channel member, a measuring channel used for measuring a liquid flow rate; and a sensor unit having a heating resistor that transfers heat to the plate member and a temperature detecting resistor that determines a temperature of the plate member. The channel member includes a flat surface in which a first groove is formed, an inflow channel having a circular cross section connected to one end in axis direction along the axis of the first groove, and an outflow channel having a circular cross section connected to the other end in the axis direction of the first groove, and inner diameters of positions of the flat surface at which the inflow channel and the outflow channel are opened, respectively, are larger than the width of the first groove.

### CROSS-REFERENCE TO RELATED APPLICATIONS

This application claims foreign priority benefits under U.S.C. § 119 to Japanese Patent Application No. 2022-116556 filed on Jul. 21, 2022, the contents of which is hereby incorporated by reference in its entirety.

### BACKGROUND

### 1. Technical Field

The present disclosure relates to a thermal type flowmeter and a manufacturing method of a thermal type flowmeter.

### 2. Description of Related Art

Thermal type flowmeters that control the temperature of a liquid flowing through a channel and measure the flow rate based on a difference in temperatures between the liquid in upstream and the liquid in downstream of a temperature-controlled section are conventionally known (for example, Japanese Patent Application Laid-Open No. 2006-10322).

Japanese Patent Application Laid-Open No. 2006-10322 discloses a thermal type flowmeter. In this thermal type flowmeter, a rectangular groove is formed in one glass substrate, another glass substrate having a heat transfer component and a temperature detection component formed thereon is attached to the groove-formed side of the one glass substrate, and thereby a channel whose liquid contact part is entirely made of glass is formed.

The thermal type flowmeter disclosed in Japanese Patent Application Laid-Open No. 2006-10322 transfers heat to a liquid subjected to measurement from the heat transfer component via the glass substrate, determines the temperatures of the liquid subjected to measurement by the temperature detection components arranged in upstream and downstream of the heat transfer component, and thereby derives the flow rate of the liquid subjected to measurement.

The channel whose liquid contact part is entirely made of glass has a disadvantage of low corrosion resistance against alkaline liquids because of a neutralization reaction between silicon dioxide, which is the main component of glass, and an alkaline liquid. Thus, to measure the flow rate of an alkaline liquid, it is preferable to use a channel formed of a resin material having high corrosion resistance against alkaline liquids. For example, instead of the glass substrate having the groove formed therein as illustrated in Japanese Patent Application Laid-Open No. 2006-10322, it is preferable to use a resin channel member having a groove for flow rate measurement formed therein.

To guide a liquid to the groove formed in the resin channel member, an inflow channel to which a liquid is guided from an inflow port is formed in the channel member and thus connected to one end of the groove. Further, an outflow channel that guides a liquid to an outflow port is formed in the channel member and thus connected to the other end of the groove. Further, when a micro-flow rate (for example, 0.01 mL/min or greater and 30 mL/min or less) is measured by using a straight channel formed in the resin channel member, it is preferable to reduce the width of the groove formed in the resin channel member (for example, 0.2 mm or greater and 1 mm or less).

In reducing the width of the groove for flow rate measurement, however, this requires high machining accuracy that matches the centers of the inflow channel and the outflow channel to the center of the groove in order to form the inflow channel in the channel member by cutting machining so that the inflow channel has the same diameter as the width of the groove and thereby is connected to one end of the groove and form the outflow channel in the channel member by cutting machining so that the outflow channel has the same diameter as the width of the groove and thereby is connected to the other end of the groove, for example.

Without high machining accuracy being achieved, the inflow channel may not be suitably connected to one end of the groove, or the outflow channel may not be suitably connected to the other end of the groove. For example, the connecting part between the inflow channel and the one end of the groove or the connecting part between the other end of the groove and the outflow channel may be excessively narrower than the width of the groove or may have a level difference. In such a case, a pressure loss may occur, or disturbance may occur in a liquid flow, and this will reduce the accuracy of flow rate measurement.

### BRIEF SUMMARY

The present disclosure has been made in view of such circumstances and intends to provide a thermal type flowmeter and a manufacturing method of a thermal type flowmeter that enable easy formation of a measuring channel, an inflow channel connected to one end of the measuring channel, and an outflow channel connected to the other end of the measuring channel in the channel member and enable accurate measurement of a flow rate while enhancing corrosion resistance against corrosive liquids such as alkaline liquids or acidic liquids.

To solve the above problem, the present disclosure employs the following solutions.

The thermal type flowmeter according to one aspect of the present disclosure includes: a resin channel member configured to cause a liquid flowing in from an inflow port to flow out of an outflow port; a plate member attached to the channel member and defining, together with the channel member, a measuring channel used for measuring a flow rate of a liquid; and a sensor unit having a heating resistor and a temperature detecting resistor, the heating resistor being configured to transfer heat to the plate member, and the temperature detecting resistor being configured to determine a temperature of the plate member to which heat of the liquid flowing through the measuring channel is transferred. The channel member includes a flat surface in which a first groove having a predetermined width and extending straight along an axis is formed, an inflow channel having a circular cross section, the inflow channel being connected to one end in an axis direction along the axis of the first groove, and a liquid flowing in from the inflow port being guided to the inflow channel, and an outflow channel having a circular cross section, the outflow channel being connected to the other end in the axis direction of the first groove and configured to guide a liquid to the outflow port, and each of a first inner diameter of a position of the flat surface at which the inflow channel is opened and a second inner diameter of a position of the flat surface at which the outflow channel is opened is larger than a width of the first groove.

According to the thermal type flowmeter of one aspect of the present disclosure, since the channel member having the first groove formed therein that serves as a measuring channel used for measuring a liquid flow rate is made of a resin, it is possible to enhance corrosion resistance against corrosive liquids. Further, it is possible to measure a liquid flow rate by attaching the plate member to the flat surface of the channel member having the first groove formed therein and detecting heat transferred from the heating resistor of the sensor unit to the liquid via the plate member as the temperature of the plate member determined by the temperature detecting resistor.

Further, each of the first inner diameter of the position of the flat surface at which the inflow channel is opened and the second inner diameter of the position of the flat surface at which the outflow channel is opened is larger than the width of the first groove. Thus, even when the centers of the inflow channel and the outflow channel are slightly shifted from the center of the first groove, the inflow channel is suitably connected to one end of the first groove, or the outflow channel is suitably connected to the other end of the first groove. It is therefore possible to achieve easy formation of the first groove, the inflow channel, and the outflow channel in the channel member and accurate measurement of a flow rate.

In the thermal type flowmeter according to one aspect of the present disclosure, a preferable configuration is such that each of the first inner diameter and the second inner diameter is 1.5 times or greater of the width of the first groove.

According to the thermal type flowmeter of the present configuration, because each of the first inner diameter and the second inner diameter is 1.5 times or greater of the width of the first groove, the inflow channel can be suitably connected to one end of the first groove, or the outflow channel can be reliably connected to the other end of the first groove, even when the centers of the inflow channel and the outflow channel are slightly shifted from the center of the first groove.

In the thermal type flowmeter according to one aspect of the present disclosure, a preferable configuration is such that the width of the first groove is 0.2 mm or greater and 1 mm or less.

According to the thermal type flowmeter of the present configuration, because the width of the first groove is 0.2 mm or greater and 1 mm or less, the reduced channel sectional area of the measuring channel can facilitate a liquid to be heated by the heating resistor, and measuring accuracy of a liquid flow rate can be increased.

In the thermal type flowmeter according to one aspect of the present disclosure, a preferable configuration is such that the plate member is formed of sapphire or glassy carbon.

According to the thermal type flowmeter of the present configuration, since the plate member is formed of sapphire or glassy carbon, the thermal type flowmeter can achieve sufficient corrosion resistance against corrosive liquids such as alkaline liquids, strong acids (hydrofluoric acid, sulfuric acid, or the like), or the like.

In the thermal type flowmeter according to one aspect of the present disclosure, a preferable configuration is such that the sensor unit is deposited on the plate member.

According to the thermal type flowmeter of the present configuration, since the sensor unit is deposited on the plate member, the plate member can be directly heated by the heating resistor, and the temperature of the plate member can be directly determined by the temperature detecting resistor.

In the thermal type flowmeter according to one aspect of the present disclosure, a preferable configuration is such that a second groove annularly extending so as to surround the first groove is formed in the flat surface, and the thermal type flowmeter includes an annular seal member inserted in the second groove and contacted with the plate member to form an annular seal area surrounding the first groove.

According to the thermal type flowmeter of the present configuration, since the annular seal member is inserted in the second groove formed in the flat surface and forms the annular seal area surrounding the first groove, it is possible to reliably prevent a liquid flowing through the measuring channel from leaking out of the seal area.

In the thermal type flowmeter according to one aspect of the present disclosure, a preferable configuration is such that the sensor unit is arranged at a position closer to the outflow channel than to the inflow channel in the axis direction.

According to the thermal type flowmeter of the present configuration, because the sensor unit is arranged at a position closer to the outflow channel than to the inflow channel, a liquid flowing from the inflow channel into the first groove is able to reach the measuring position of the sensor unit with disturbance or the like of the liquid being sufficiently reduced and the speed thereof being stabilized.

In a manufacturing method of a thermal type flowmeter according to one aspect of the present disclosure, the thermal type flowmeter includes a resin channel member configured to cause a liquid flowing in from an inflow port to flow out of an outflow port, a plate member attached to the channel member and defining, together with the channel member, a measuring channel used for measuring a flow rate of a liquid, and a sensor unit having a heating resistor and a temperature detecting resistor, the heating resistor being configured to transfer heat to the plate member, and the temperature detecting resistor being configured to determine a temperature of the plate member to which heat of the liquid flowing through the measuring channel is transferred, the manufacturing method includes: cutting a flat surface of the channel member to form a first groove having a predetermined width and extending straight along an axis; cutting the channel member to form an inflow channel having a circular cross section, the inflow channel being connected to one end in an axis direction along the axis of the first groove, and a liquid flowing in from the inflow port being guided to the inflow channel; cutting the channel member to form an outflow channel having a circular cross section, the outflow channel being connected to the other end in axis direction of the first groove and configured to guide a liquid to the outflow port; and forming the measuring channel by attaching the plate member to the flat surface of the channel member in which the first groove, the inflow channel, and the outflow channel are formed, and each of a first inner diameter of a position of the flat surface at which the inflow channel is opened and a second inner diameter of a position of the flat surface at which the outflow channel is opened is larger than a width of the first groove.

According to the manufacturing method of a thermal type flowmeter of one aspect of the present disclosure, since the channel member having the first groove formed therein that serves as a measuring channel used for measuring a liquid flow rate is made of a resin, it is possible to enhance corrosion resistance against alkaline liquids. Further, it is possible to measure a liquid flow rate by attaching the plate member to the flat surface of the channel member having the first groove formed therein and detecting heat transferred from the heating resistor of the sensor unit to the liquid via the plate member as the temperature of the plate member determined by the temperature detecting resistor.

Further, each of the first inner diameter of the position of the flat surface at which the inflow channel is opened and the second inner diameter of the position of the flat surface at which the outflow channel is opened is larger than the width of the first groove. Thus, even when the center of the inflow channel is slightly shifted from the center of the first groove when the inflow channel having a circular cross section at one end of the first groove is cut and formed, the inflow channel can be suitably connected to one end of the first groove. Similarly, even when the center of the outflow channel is slightly shifted from the center of the first groove when the outflow channel having a circular cross section at the other end of the first groove is cut and formed, the outflow channel can be suitably connected to the other end of the first groove. It is therefore possible to achieve easily formation of the measuring channel, the inflow channel, and the outflow channel in the channel member and accurate measurement of a flow rate.

According to the present disclosure, it is possible to provide a thermal type flowmeter and a manufacturing method of a thermal type flowmeter that enable easy formation of a measuring channel, an inflow channel connected to one end of the measuring channel, and an outflow channel connected to the other end of the measuring channel in the channel member and enable accurate measurement of a flow rate while enhancing corrosion resistance against corrosive liquids such as alkaline liquids or acidic liquids.

### BRIEF DESCRIPTION OF THE SEVERAL VIEWS OF THE DRAWINGS

FIG. 1 is a partial longitudinal sectional view of a thermal type flowmeter according to one embodiment of the present disclosure.

FIG. 2 is an exploded view of the thermal type flowmeter illustrated in FIG. 1.

FIG. 3 is a sectional view of the thermal type flowmeter illustrated in FIG. 1.

FIG. 4 is a plan view of the thermal type flowmeter illustrated in FIG. 3.

FIG. 5 is a plan view of a channel unit illustrated in FIG. 4.

FIG. 6 is a partial enlarged view of a part A of a channel member illustrated in FIG. 5.

FIG. 7 is a partial enlarged view of a channel member of a thermal type flowmeter of a comparative example.

FIG. 8 is a sectional view taken along the arrow B-B of the thermal type flowmeter illustrated in FIG. 4.

FIG. 9 is a sectional view taken along the arrow C-C of the thermal type flowmeter illustrated in FIG. 8.

FIG. 10 is a plan view of a sensor unit formed in a temperature detection surface of a plate member.

FIG. 11 is a plan view illustrating a state where a sensor unit formed on a glass substrate is joined to the temperature detection surface of the plate member.

FIG. 12 is a plan view illustrating a state where a first groove and a second groove are formed in a flat surface of the channel member.

### DETAILED DESCRIPTION

A thermal type flowmeter 100 according to one embodiment of the present disclosure will be described below with reference to the drawings.

The thermal type flowmeter 100 of the present embodiment is a device that heats a liquid flowing through an internal channel, determines the temperature of the heated liquid, and thereby measures the flow rate of the liquid. The thermal type flowmeter 100 of the present embodiment is suitable for measuring a micro-flow rate such as, for example, 0.1 ml/min to 30 ml/min. A liquid subjected to flow rate measurement by the thermal type flowmeter 100 of the present embodiment is a corrosive liquid such as alkaline liquids or acidic liquids. The corrosive liquid is a chemical solution used in a semiconductor manufacturing apparatus, such as ammonia water, hydrofluoric acid, hydrochloric acid, or the like, for example.

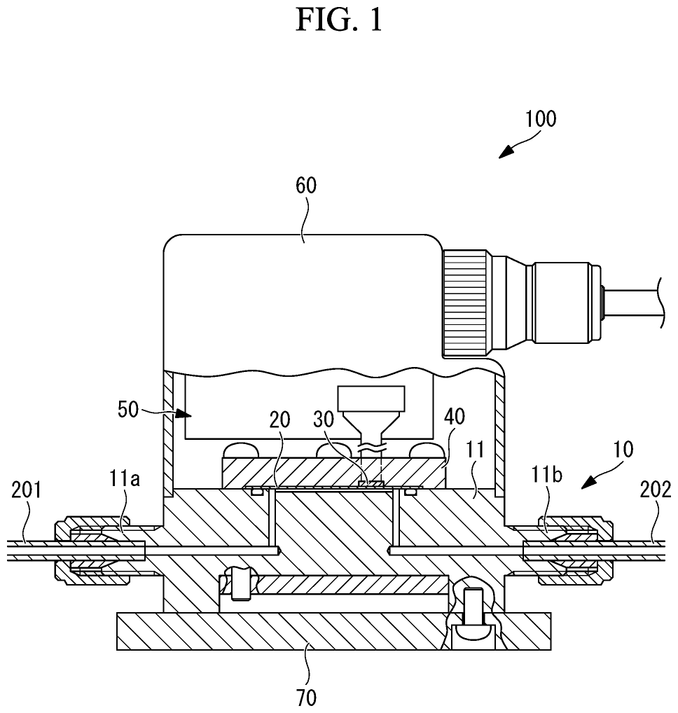

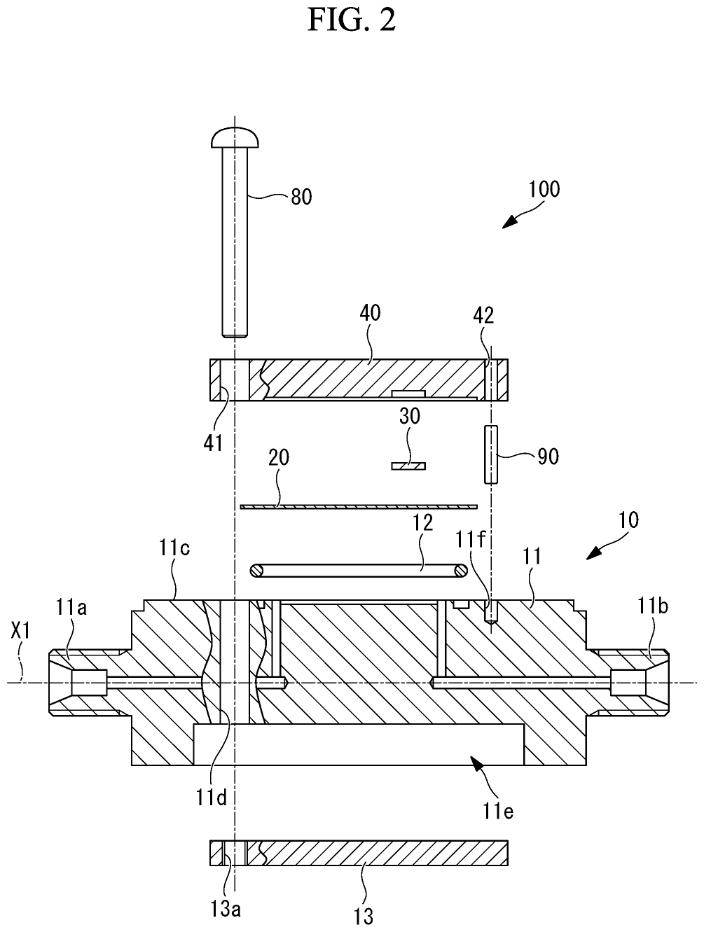

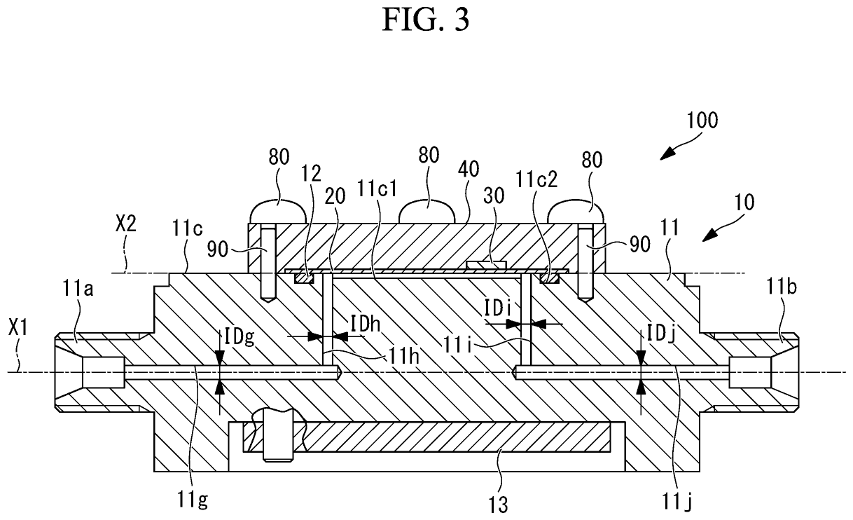

FIG. 1 is a partial longitudinal sectional view of the thermal type flowmeter 100 according to one embodiment of the present disclosure. FIG. 2 is an exploded view of the thermal type flowmeter 100 illustrated in FIG. 1. FIG. 3 is a sectional view of the thermal type flowmeter 100 illustrated in FIG. 1. As illustrated in FIG. 1 and FIG. 2, the thermal type flowmeter 100 of the present embodiment includes a channel unit 10, a plate member 20, a sensor unit 30, a sensor cover 40, a control substrate 50, an upper case 60, a bottom case 70, screws 80, and positioning pins 90.

The upper case 60 is a member serving as an upper casing of the thermal type flowmeter 100 and accommodates the control substrate 50 therein. The bottom case 70 is a member serving as a lower casing of the thermal type flowmeter 100 and attached to the channel unit 10. In FIG. 2 and FIG. 3, depiction of the upper case 60 and the bottom case 70 is omitted.

The channel unit 10 is a unit having a channel formed therein that causes a liquid flowing in from an inflow port 11a connected to an external pipe 201 to flow out of an outflow port 11b connected to an external pipe 202. The channel unit 10 has a channel member 11, an O-ring (annular seal member) 12, and a base 13.

As illustrated in FIG. 2 and FIG. 3, through holes 11d, a recess 11e, and positioning holes 1 if are formed in the channel member 11. Internal threads 13a are formed in the base 13. Through holes 41 and positioning holes 42 are formed in the sensor cover 40. The screws 80 are inserted in the through holes 41 and the through holes 11d, fastened into the internal threads 13a of the base 13 arranged in the recess 11e, and thereby the channel unit 10 and the sensor cover 40 are coupled into one piece.

As illustrated in FIG. 3, once the channel unit 10 and the sensor cover 40 are coupled into one piece, the plate member 20 and the sensor unit 30 are arranged between the channel unit 10 and the sensor cover 40. The positioning pins 90 are inserted in both the positioning holes 11f and the positioning holes 42, and thereby the position of the sensor cover 40 on a flat surface 11c of the channel member 11 is fixed.

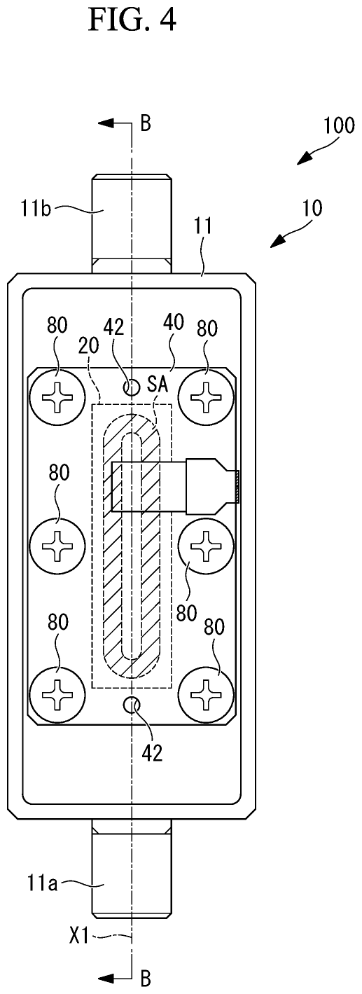

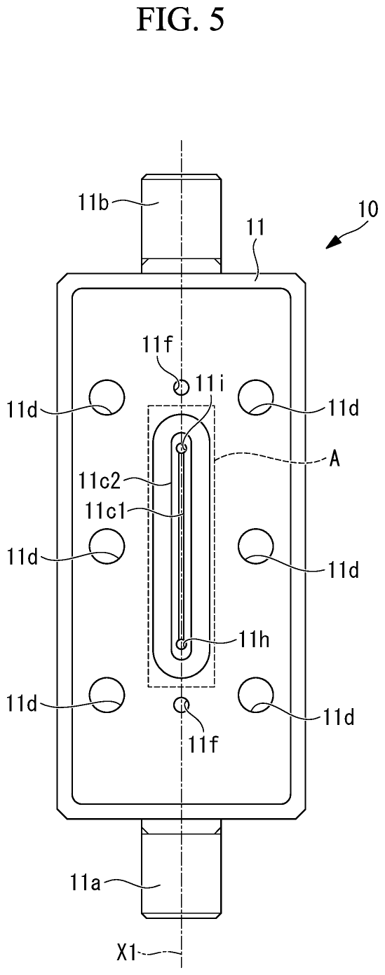

FIG. 4 is a plan view of the thermal type flowmeter 100 illustrated in FIG. 3. FIG. 5 is a plan view of the channel unit 10 illustrated in FIG. 4. As illustrated in FIG. 5, six through holes 11d are formed in the channel member 11. The screws 80 are inserted in six through holes 41 of the sensor cover 40 and the six through holes 11d of the channel member 11, respectively, and fastened into six internal threads 13a of the base 13.

The channel member 11 is a member that causes a liquid flowing in from the inflow port 11a to flow out of the outflow port 11b. The channel member 11 is formed of a resin material having high corrosion resistance (for example, a fluorine resin material such as polytetrafluoroethylene (PTFE)). As illustrated in FIG. 3, the flat surface 11c extending in the horizontal direction is formed above the channel member 11. The channel member 11 has a flat surface 11c, an introduction channel 11g, an inflow channel 11h, an outflow channel 11i, and a delivery channel 11j.

A first groove 11c1 and a second groove 11c2 are formed in the flat surface 11c. The first groove 11c1 is formed so as to extend straight along an axis X2 on the flat surface 11c. The flat surface 11c around the first groove 11c1 is sealed by the plate member and thereby a measuring channel for measuring the flow rate of a liquid by the sensor unit is formed.

As illustrated in FIG. 5, the second groove 11c2 extends annularly so as to surround the first groove 11c1. As illustrated in FIG. 3, the O-ring 12 is inserted in the second groove 11c2 and forms an annular seal area SA surrounding the first groove 11c1 (see FIG. 4).

As illustrated in FIG. 3, the introduction channel 11g is a straight channel extending in the horizontal direction along an axis X1 and having a circular cross section and has an inner diameter of IDg. The inflow channel 11h is a straight channel having a circular cross section to which a liquid flowing in from the inflow port 11a via an introduction channel 11g is guided and has an inner diameter of IDh (first inner diameter). The inner diameter IDh is smaller than the inner diameter IDg and is set to, for example, 0.3 mm or larger and 1.5 mm or smaller. The inner diameter IDh has the same size from one end connected to the introduction channel 11g to the other end connected to the first groove 11c1.

The outflow channel 11i is a straight channel having a circular cross section that guides a liquid to the outflow port 11b via the delivery channel 11j and has an inner diameter of IDi (second inner diameter). The inner diameter IDi may be the same as the inner diameter IDh. The inner diameter IDi has the same size from one end connected to the first groove 11c1 to the other end connected to the delivery channel 11j. The delivery channel 11j is a straight channel extending in the horizontal direction along the axis X1 and having a circular cross section and has an inner diameter of IDj. The inner diameter IDj is larger than the inner diameter IDi and is set to, for example, 0.3 mm or larger and 1.5 mm or smaller. The inner diameter IDj may be the same as the inner diameter IDg.

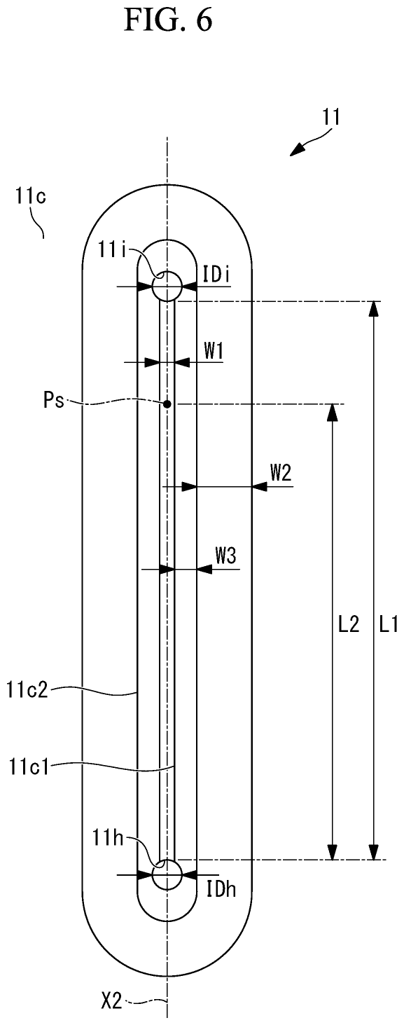

FIG. 6 is a partial enlarged view of the part A of the channel member 11 illustrated in FIG. 5. As illustrated in FIG. 6, the first groove 11c1 is formed in the flat surface 11c and extends straight along the axis X2. The inflow channel 11h is connected to one end in the axis direction along the axis X2 of the first groove 11c1. The outflow channel 11i is connected to the other end in the axis direction along the axis X2 of the first groove 11c1. The center of the inflow channel 11h and the center of the outflow channel 11i are on the axis X2, respectively, and match the center of the first groove 11c1.

As illustrated in FIG. 6, the inner diameter IDh at a position of the flat surface 11c at which the inflow channel 11h is opened and the inner diameter IDi at a position of the flat surface 11c at which the outflow channel 11i is opened are larger than the width W1 on the flat surface 11c in a direction orthogonal to the axis X2 of the first groove 11c1. The inner diameter IDh and the inner diameter IDi are preferably 1.5 times or greater and 3 times or less of the width W1 of the first groove 11c1.

When each of the inner diameter IDh and the inner diameter IDi is 1.5 times or greater of the width of the first groove 11c1, the inflow channel 11h can be suitably connected to one end of the first groove 11c1, or the outflow channel 11i can be reliably connected to the other end of the first groove 11c1, even when the centers of the inflow channel 11h and the outflow channel 11i are slightly shifted from the center of the first groove 11c1. Further, when each of the inner diameter IDh and the inner diameter IDi is 3 times or less of the width of the first groove 11c1, an excessively large difference between each channel sectional area of the inflow channel 11h and the outflow channel 11i and the channel sectional area of the first groove 11c1 can be avoided.

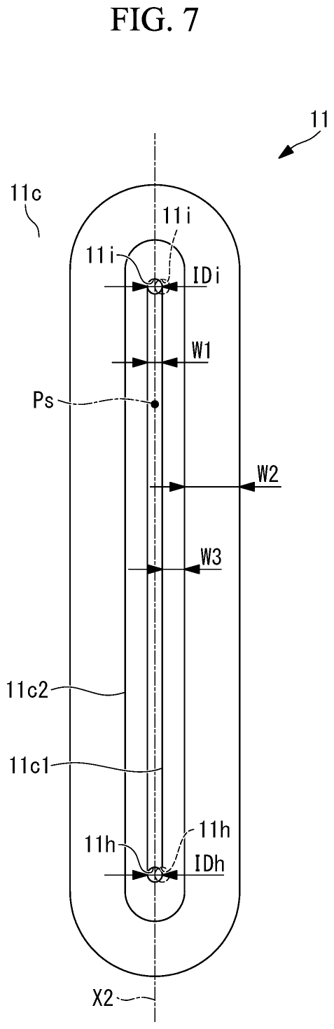

FIG. 7 is a partial enlarged view of the channel member 11 of a thermal type flowmeter of a comparative example. The channel member 11 of the thermal type flowmeter of the comparative example differs from the channel member 11 of FIG. 6 in that the inner diameter IDh and the inner diameter IDi are the same length as the width W1 of the first groove 11c1. In FIG. 7, the inflow channel 11h and the outflow channel 11i indicated by solid lines represent a state where the centers of the inflow channel 11h and the outflow channel 11i are matched to the center of the first groove 11c1.

On the other hand, in FIG. 7, the inflow channel 11h and the outflow channel 11i indicated by dotted lines represent a state where the centers of the inflow channel 11h and the outflow channel 11i are shifted by half the inner diameter IDh and by half the inner diameter IDi from the center of the first groove 11c1, respectively. As illustrated in FIG. 7, if the centers of the inflow channel 11h and the outflow channel 11i are shifted from the center of the first groove 11c1 due to machining accuracy of cutting machining (drilling machining), this will result in a state where the inflow channel 11h and the outflow channel 11i are not suitably connected to the ends of the first groove 11c1.

As illustrated in FIG. 6, in the channel member 11 of the present embodiment, the width W2 in the flat surface 11c in the direction orthogonal to the axis X2 of the second groove 11c2 is larger than the width W1. Further, the width W3 of the flat surface 11c between the first groove 11c1 and the second groove 11c2 is larger than W1 and smaller than W2. The width W1 in the direction orthogonal to the axis X2 of the first groove 11c1 is preferably 0.2 mm or greater and 1 mm or less.

As illustrated in FIG. 6, the length in the axis direction along the axis X2 from one end of the first groove 11c1 (the connecting position to the inflow channel 11h) to the other end of the first groove 11c1 (the connecting position to the outflow channel 11i) is L1. Further, the distance in the axis direction from one end of the first groove 11c1 to a measuring position Ps is L2. The measuring position Ps is the center position in the axis direction along the axis X2 of the sensor unit 30.

The length L2 is preferably longer than the half of the length L1. For example, the length L2 is preferably set to 0.6 times or greater and 0.9 times or less of the length L1. In such a way, the sensor unit 30 is preferably arranged at a position closer to the outflow channel 11i than to the inflow channel 11h in the axis direction. Because the sensor unit 30 is arranged at a position closer to the outflow channel 11i than to the inflow channel 11h, a liquid flowing from the inflow channel 11h into the first groove 11c1 is able to reach the measuring position Ps of the sensor unit 30 with disturbance or the like of the liquid being sufficiently reduced and the speed thereof being stabilized.

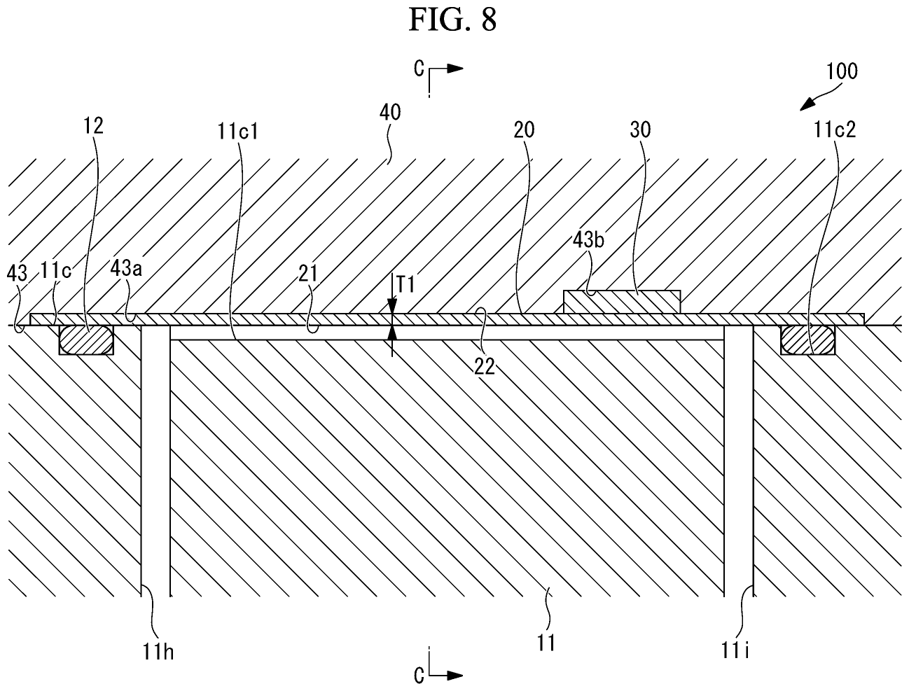

FIG. 8 is a sectional view taken along the arrow B-B of the thermal type flowmeter 100 illustrated in FIG. 4. As illustrated in FIG. 8, the plate member 20 is a member that is attached to the channel member 11 and defines a measuring channel used for measuring a flow rate of a liquid by the sensor unit 30 together with the first groove 11c1 of the channel member 11. The plate member 20 has a liquid contact surface 21 contacted with a liquid flowing through the flat surface 11c and the first groove 11c1 and a temperature detection surface 22 used for determining the temperature of a liquid transferred from the liquid contact surface 21 by the sensor unit 30.

The plate member 20 is formed of sapphire that is a material having high corrosion resistance against alkaline liquids. The plate member 20 may be formed of glassy carbon. It is preferable to form a film having a low gas permeability coefficient on the liquid contact surface 21 of the plate member 20 so that a corrosive gas does not permeate therethrough.

The plate member 20 is formed to have a constant thickness T1 at respective positions. For example, the thickness T1 is preferably set to 0.1 mm or greater and 0.4 mm or less. The plate member 20 is accommodated in a recess 43a formed in a contact surface 43 of the sensor cover 40.

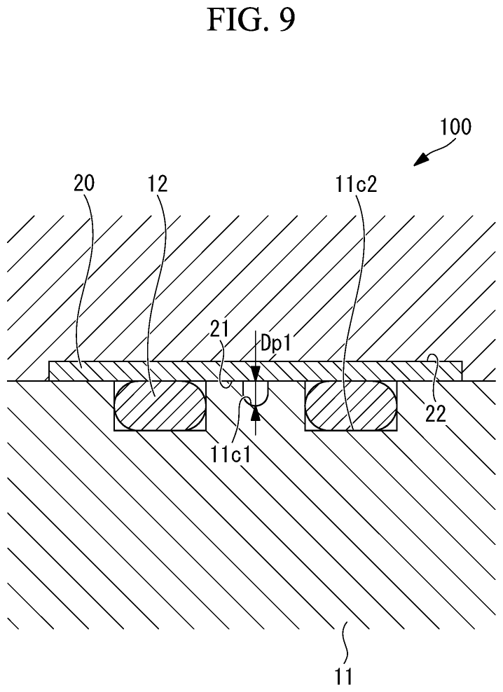

FIG. 9 is a sectional view taken along the arrow C-C of the thermal type flowmeter 100 illustrated in FIG. 8. As illustrated in FIG. 9, the first groove 11c1 formed in the channel member 11 has substantially a semi-circular cross section. The depth Dp1 from the liquid contact surface 21 of the plate member 20, which seals the first groove 11c1, to the bottom of the first groove 11c1 is larger than the width W1 of the first groove 11c1. The depth Dp1 is preferably 0.5 times to 2 times (preferably 1 time) of the width W1.

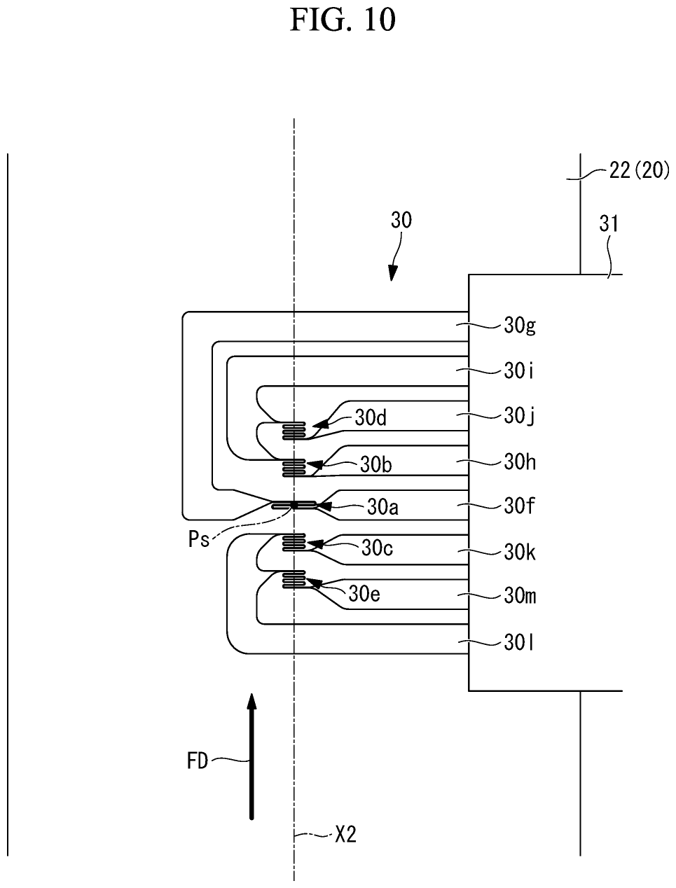

FIG. 10 is a plan view of the sensor unit 30 formed in the temperature detection surface 22 of the plate member 20. As illustrated in FIG. 10, the sensor unit 30 is a device that measures the flow rate of a liquid flowing through the measuring channel defined by the first groove 11c1 and the plate member 20 and transmits the measured flow rate to the control substrate 50. The sensor unit 30 has a heating resistor 30a that transfers heat to the plate member 20 and temperature detecting resistors 30b, 30c, 30d, 30e that determine the temperature of the plate member 20 to which the heat of the liquid flowing through the measuring channel is transferred.

The heating resistor 30a and the temperature detecting resistors 30b, 30c, 30d, are each formed by depositing a film of a metal such as platinum on a glass substrate by a Chemical Vapor Deposition (CVD) method or the like. Other methods such as sputtering, photolithography, or the like may be used to form the heating resistor 30a and the temperature detecting resistors 30b, 30c, 30d, 30e on the temperature detection surface 22 of the plate member 20.

The sensor cover 40 is a member for accommodating the plate member 20 and the sensor unit 30 between the sensor cover 40 and the channel unit 10. As illustrated in FIG. 8, the sensor cover 40 has the contact surface 43. The contact surface 43 is a surface contacted with the flat surface 11c of the channel member 11 when the channel unit 10 and the sensor cover 40 are coupled into one piece by the screws 80. The recess 43a is formed in the flat surface 11c and has a depth that is the same as or slightly smaller than the thickness T1 of the plate member 20. The recess 43b is formed in the recess 43a and is a portion that accommodates the sensor unit 30.

The control substrate 50 is a device that transmits a voltage signal to the heating resistor 30a of the sensor unit 30 to heat the heating resistor 30a and calculates a flow rate of a liquid based on temperatures transmitted from the temperature detecting resistors 30b, 30c, 30d, 30e. The control substrate 50 outputs a voltage signal used for heating the heating resistor 30a to the sensor unit 30 via a flexible substrate 31. Further, the control substrate 50 outputs voltage signals used for determining the resistance values of the temperature detecting resistors 30b, 30c, 30d, 30e to the sensor unit 30 via the flexible substrate 31.

The control substrate 50 outputs a voltage signal to the heating resistor 30a so as to periodically repeat a heating period to heat the heating resistor 30a and a non-heating period not to heat the heating resistor 30a. The heating period is set to be shorter than the non-heating period. That is, the heating period is set to a ratio that is less than 0.5 with respect to one cycle that is a sum of one heating period and one non-heating period. The ratio with respect to one cycle of the heating period may be set to be less than 0.4.

The liquid flowing through a measuring channel flows along the axis X2 in the flow direction FD from below to above in FIG. 10. Thus, in response to instantaneous heating to the heating resistor 30a, the heated liquid flows along the axis X2, reaches the position of the temperature detecting resistor 30b, and then reaches the position of the temperature detecting resistor 30d. The control substrate 50 determines the electrical resistance values, which change with a temperature, of the temperature detecting resistor 30b and the temperature detecting resistor 30d and thereby measures the temperature of the plate member 20 near the temperature detecting resistor 30b and the temperature detecting resistor The control substrate 50 can calculate the flow speed of a liquid flowing through the measuring channel from a timing of instantaneously heating the heating resistor and a subsequent timing of the temperature detecting resistor 30b and the temperature detecting resistor 30d determining the temperature of the heated liquid. Further, the control substrate 50 can calculate a flow rate of the liquid from the calculated flow speed and the sectional area of the first groove 11c1.

In response to instantaneous heating of the heating resistor 30a, the heat transferred from the heating resistor 30a to the temperature detection surface 22 is transferred in the direction opposite to the flow direction FD of the liquid along the axis X2, reaches the position of the temperature detecting resistor 30c, and then reaches the position of the temperature detecting resistor 30e. The control substrate 50 determines the electrical resistance values, which change with a temperature, of the temperature detecting resistor 30c and the temperature detecting resistor 30e and thereby measures the temperatures of the temperature detecting resistor 30c and the temperature detecting resistor 30e.

The control substrate 50 subtracts the temperature of the temperature detecting resistor 30c from the temperature of the temperature detecting resistor 30b. The temperature determined by the temperature detecting resistor 30c upstream in the flow direction FD of the heating resistor 30a corresponds to the heat that is not transferred to the liquid and is transferred to the temperature detecting resistor 30c via the plate member 20 out of the heat transferred to the plate member 20 by the heating resistor 30a. The temperature detecting resistor 30b and the temperature detecting resistor 30c are arranged at the same distance from the heating resistor 30a.

Thus, by subtracting the temperature of the temperature detecting resistor 30c from the temperature of the temperature detecting resistor 30b, it is possible to measure the temperature of the liquid passing through the position of the temperature detecting resistor 30b. Similarly, the control substrate 50 subtracts the temperature of the temperature detecting resistor 30e from the temperature of the temperature detecting resistor 30d and thereby can measure the temperature of the liquid passing through the position of the temperature detecting resistor 30d.

As illustrated in FIG. 10, a wiring pattern 30f connected to one end of the heating resistor 30a and a wiring pattern 30g connected to the other end of the heating resistor 30a are formed on the temperature detection surface 22. Further, a wiring pattern connected to one end of the temperature detecting resistor 30b, a wiring pattern 30i connected to the other end of the temperature detecting resistor 30b, and a wiring pattern 30j connected to one end of the temperature detecting resistor 30d are formed on the temperature detection surface 22. The other end of the temperature detecting resistor 30d is connected to the wiring pattern 30i.

Further, a wiring pattern 30k connected to one end of the temperature detecting resistor 30c, a wiring pattern 30l connected to the other end of the temperature detecting resistor 30c, and a wiring pattern 30m connected to one end of the temperature detecting resistor 30e are formed on the temperature detection surface 22. The other end of the temperature detecting resistor 30e is connected to the wiring pattern 30l. The wiring patterns 30f, 30g, 30h, 30i, 30j, 30k, 30l, 30m are each formed by depositing a film of a metal such as platinum on the glass substrate.

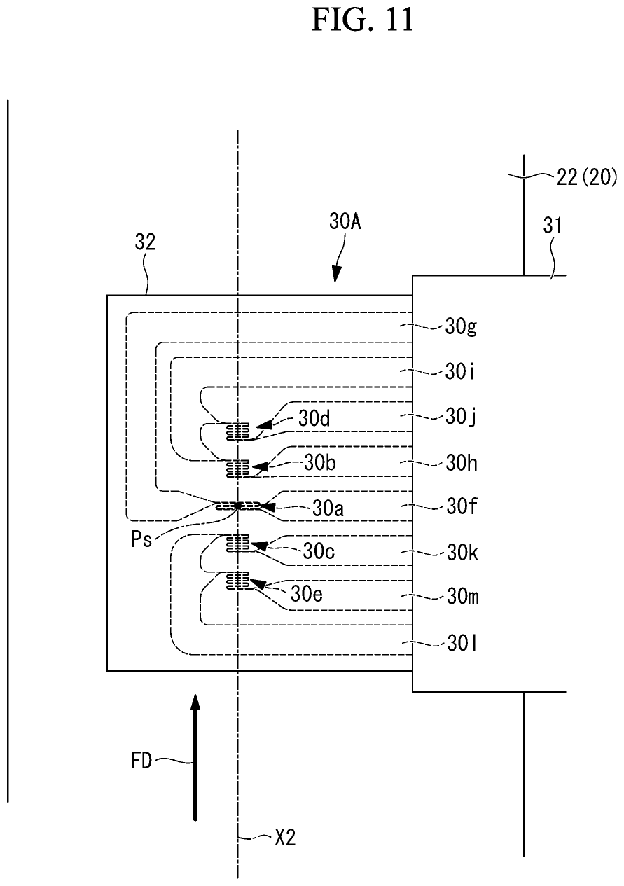

Although the sensor unit 30 illustrated in FIG. 10 is formed such that the heating resistor 30a and the temperature detecting resistors 30b, 30c, 30d, 30e are directly formed on the temperature detection surface 22 of the plate member 20, other forms may be employed. For example, as illustrated in FIG. 11, a form in which the sensor unit 30 formed on a glass substrate 32 is joined to the temperature detection surface 22 of the plate member may be employed.

FIG. 11 is a plan view illustrating a state where a sensor unit 30A formed on the glass substrate 32 is joined to the temperature detection surface 22 of the plate member 20. The sensor unit 30A illustrated in FIG. 11 is formed by depositing the heating resistor and the temperature detecting resistors 30b, 30c, 30d, 30e on one surface of the glass substrate 32. The surface of the glass substrate 32 having the heating resistor 30a and the temperature detecting resistors 30b, 30c, 30d, 30e formed therein is joined to the temperature detection surface 22 of the plate member 20 via an adhesive agent.

The sensor unit 30A illustrated in FIG. 11 is disadvantageous in terms of thermal conductivity and temperature detection response compared to the sensor unit 30 illustrated in FIG. 10, because an adhesive agent is interposed between the plate member 20 and the temperature detection surface 22. However, the sensor unit 30A illustrated in FIG. 11 has good productivity, because the heating resistor 30a and the temperature detecting resistors 30b, 30c, 30d, 30e are not directly formed on the plate member 20. For example, by employing the glass substrate 32 having sufficiently larger thickness and higher strength than the plate member 20, it is possible to prevent breakage from occurring when forming the heating resistor 30a and the temperature detecting resistors 30b, 30c, 30d, 30e.

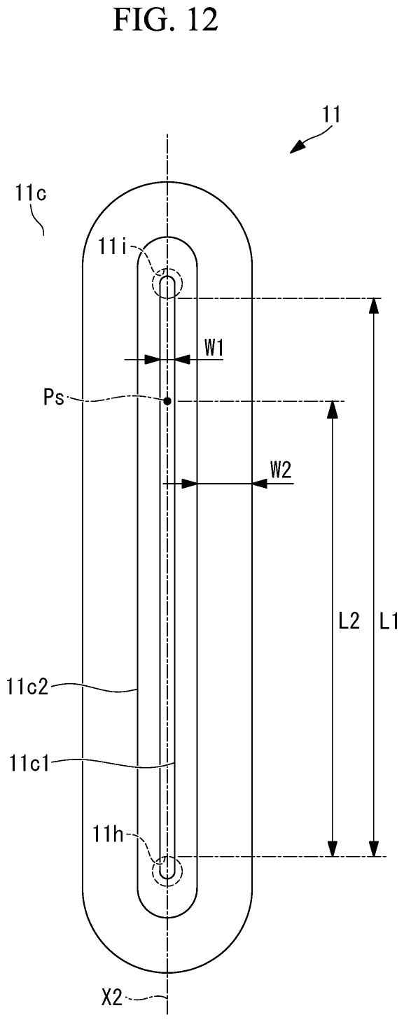

Next, the manufacturing method of the thermal type flowmeter 100 of the present embodiment will be described. FIG. 12 is a plan view illustrating a state where the first groove 11c1 and the second groove 11c2 are formed in the flat surface 11c of the channel member 11. In the manufacturing method of the present embodiment, the channel member 11 of the channel unit 10 is manufactured by the following procedure.

First, the flat surface 11c of the channel member 11 is cut to form the straight first groove 11c1 having the width W1 and the annular second groove 11c2 having the width W2. The first groove 11c1 and the second groove 11c2 are formed by milling using an endmill. The flat surface 11c of the channel member 11 having the first groove 11c1 and the second groove 11c2 formed therein is in a state illustrated in FIG. 12.

Next, the channel member 11 is cut to form the inflow channel 11h having a circular cross section so as to be connected to one end in the axis direction along the axis X2 of the first groove 11c1. The inflow channel 11h is formed by pushing a drill (not illustrated) in a direction orthogonal to the flat surface 11c against the position indicated by the dotted line in FIG. 12.

Next, the channel member 11 is cut to form the outflow channel 11i having a circular cross section so as to be connected to the other end in the axis direction along the axis X2 of the first groove 11c1. The outflow channel 11i is formed by pushing a drill (not illustrated) in a direction orthogonal to the flat surface 11c against the position indicated by the dotted line in FIG. 12. Note that the outflow channel 11i may be formed earlier than the inflow channel 11h.

Next, the channel member 11 is cut to form the introduction channel 11g and the delivery channel 11j having a circular cross section extending in the axis X1. The introduction channel 11g and the delivery channel 11j are formed by pushing a drill (not illustrated) against the side surface of the channel member 11 along the axis X1.

Next, the O-ring 12 is inserted in the second groove 11c2, and the plate member 20 accommodated in the recess 43a of the sensor cover 40 is attached to the flat surface 11c of the channel member 11 in contact therewith. When the liquid contact surface 21 of the plate member 20 is in contact with the flat surface 11c, the measuring channel through which a liquid flows is defined by the liquid contact surface 21 and the first groove 11c1.

Next, the screws 80 are inserted in the through holes 41 and the through holes 11d and fastened into the internal threads 13a of the base 13 arranged in the recess 11e to couple the channel unit 10 and the sensor cover 40 into one piece. Further, the upper case 60 accommodating the control substrate 50 is attached to the upper end of the channel member 11, and the bottom case 70 is attached to the lower end of the channel member 11. As discussed above, the thermal type flowmeter 100 of the present embodiment is manufactured.

Effects and advantages achieved by the thermal type flowmeter 100 of the present embodiment illustrated above will be described.

According to the thermal type flowmeter 100 of the present embodiment, since the channel member 11 having the first groove 11c1 formed therein that serves as a measuring channel used for measuring a liquid flow rate is made of a resin, it is possible to enhance corrosion resistance against alkaline liquids. Further, it is possible to measure a liquid flow rate by attaching the plate member 20 to the flat surface 11c of the channel member 11 having the first groove 11c1 formed therein and detecting heat transferred from the heating resistor 30a of the sensor unit 30 to the liquid via the plate member 20 as the temperature of the plate member 20 determined by the temperature detecting resistors 30b, 30c, 30d, 30e.

Further, each of the inner diameter IDh at a position of the flat surface 11c at which the inflow channel 11h is opened and the inner diameter IDi at a position of the flat surface 11c at which the outflow channel 11i is opened is larger than the width W1 of the first groove 11c1. Thus, even when the centers of the inflow channel 11h and the outflow channel 11i are slightly shifted from the center of the first groove 11c1, the inflow channel 11h is suitably connected to one end of the first groove 11c1, or the outflow channel 11i is suitably connected to the other end of the first groove 11c1. It is therefore possible to achieve easy formation of the first groove 11c1, the inflow channel 11h, and the outflow channel 11i in the channel member 11 and accurate measurement of a flow rate.

According to the thermal type flowmeter 100 of the present embodiment, because each of the inner diameter IDh and the inner diameter IDi is 1.5 times or greater of the width W1 of the first groove 11c1, the inflow channel 11h can be suitably connected to one end of the first groove 11c1, or the outflow channel 11i can be reliably connected to the other end of the first groove 11c1, even when the centers of the inflow channel 11h and the outflow channel 11i are slightly shifted from the center of the first groove 11c1.

According to the thermal type flowmeter 100 of the present embodiment, because the width W1 of the first groove 11c1 is 0.2 mm or greater and 1 mm or less, the reduced channel sectional area of the measuring channel can facilitate a liquid to be heated by the heating resistor 30a, and measuring accuracy of a liquid flow rate can be increased.

According to the thermal type flowmeter 100 of the present embodiment, since the plate member 20 is formed of sapphire or glassy carbon, the thermal type flowmeter 100 can achieve sufficient corrosion resistance against alkaline liquids or strong acids (hydrofluoric acid, sulfuric acid, or the like).

According to the thermal type flowmeter 100 of the present embodiment, since the sensor unit 30 is deposited on the plate member 20, the plate member 20 can be directly heated by the heating resistor 30a, and the temperature of the plate member 20 can be directly determined by the temperature detecting resistors 30b, 30c, 30d, 30e.

According to the thermal type flowmeter 100 of the present embodiment, since the O-ring 12 is inserted in the second groove 11c2 formed in the flat surface 11c and forms the annular seal area SA surrounding the first groove 11c1, it is possible to reliably prevent a liquid flowing through the measuring channel from leaking out of the seal area SA.

What is claimed is:

1. A thermal type flowmeter comprising:
a resin channel member configured to cause a liquid flowing in from an inflow port to flow out of an outflow port;
a plate member attached to the channel member and defining, together with the channel member, a measuring channel used for measuring a flow rate of a liquid; and
a sensor unit having a heating resistor and a temperature detecting resistor, the heating resistor being configured to transfer heat to the plate member, and the temperature detecting resistor being configured to determine a temperature of the plate member to which heat of the liquid flowing through the measuring channel is transferred,
wherein the channel member includes
a flat surface in which a first groove having a predetermined width and extending straight along an axis is formed,
an inflow channel having a circular cross section, the inflow channel being connected to one end in an axis direction along the axis of the first groove, and a liquid flowing in from the inflow port being guided to the inflow channel, and
an outflow channel having a circular cross section, the outflow channel being connected to the other end in the axis direction of the first groove and configured to guide a liquid to the outflow port, and
wherein each of a first inner diameter of a position of the flat surface at which the inflow channel is opened and a second inner diameter of a position of the flat surface at which the outflow channel is opened is larger than a width of the first groove.

2. The thermal type flowmeter according to claim 1, wherein each of the first inner diameter and the second inner diameter is 1.5 times or greater of the width of the first groove.

3. The thermal type flowmeter according to claim 1, wherein the width of the first groove is 0.2 mm or greater and 1 mm or less.

4. The thermal type flowmeter according to claim 1, wherein the plate member is formed of sapphire or glassy carbon.

5. The thermal type flowmeter according to claim 1, wherein the sensor unit is deposited on the plate member.

6. The thermal type flowmeter according to claim 1, wherein a second groove annularly extending so as to surround the first groove is formed in the flat surface,
the thermal type flowmeter further comprising an annular seal member inserted in the second groove and contacted with the plate member to form an annular seal area surrounding the first groove.

7. The thermal type flowmeter according to claim 1, wherein the sensor unit is arranged at a position closer to the outflow channel than to the inflow channel in the axis direction.

8. A manufacturing method of a thermal type flowmeter, wherein the thermal type flowmeter comprising
a resin channel member configured to cause a liquid flowing in from an inflow port to flow out of an outflow port,
a plate member attached to the channel member and defining, together with the channel member, a measuring channel used for measuring a flow rate of a liquid, and
a sensor unit having a heating resistor and a temperature detecting resistor, the heating resistor being configured to transfer heat to the plate member, and the temperature detecting resistor being configured to determine a temperature of the plate member to which heat of the liquid flowing through the measuring channel is transferred,
the manufacturing method comprising:
cutting a flat surface of the channel member to form a first groove having a predetermined width and extending straight along an axis;
cutting the channel member to form an inflow channel having a circular cross section, the inflow channel being connected to one end in an axis direction along the axis of the first groove, and a liquid flowing in from the inflow port being guided to the inflow channel;
cutting the channel member to form an outflow channel having a circular cross section, the outflow channel being connected to the other end in axis direction of the first groove and configured to guide a liquid to the outflow port; and
forming the measuring channel by attaching the plate member to the flat surface of the channel member in which the first groove, the inflow channel, and the outflow channel are formed,
wherein each of a first inner diameter of a position of the flat surface at which the inflow channel is opened and a second inner diameter of a position of the flat surface at which the outflow channel is opened is larger than a width of the first groove.
